(19) United States
(12) Patent Application Publication
(10) Pub. No.: US 2025/0329774 A1
(43) Pub. Date: Oct. 23, 2025

(54) NANOSIZED SULFIDE SOLID-STATE ELECTROLYTE MATERIAL AND PREPARATION METHOD THEREOF

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Xiayin Yao, Ningbo, Zhejiang (CN); Gaozhan Liu, Ningbo, Zhejiang (CN); Jing Yang, Ningbo, Zhejiang (CN)

(21) Appl. No.: 18/283,513

(22) PCT Filed: May 31, 2023
(86) PCT No.: PCT/CN2023/097289

§ 371 Date: Nov. 5, 2024

(30) Foreign Application Priority Data
Sep. 2, 2022 (CN) 202211068813.5

(51) Int. Cl. H01M 10/0562

(52) U.S. Cl. CPC H01M 10/0562; H01M 2300/008

(57) ABSTRACT

Provided is a preparation method of a nanosized sulfide solid-state electrolyte material. The preparation method includes the following steps: (1) preparing a Li₂S material; (2) mixing 10-100 parts by weight of a solvent, 0-1 parts by weight of a dispersant, and 1 part by weight of a raw material containing the Li₂S material in a closed container, and drying the mixture to obtain an electrolyte precursor powder; and (3) heat treating, pulverizing and grinding the electrolyte precursor powder obtained in step (2) to obtain the nanosized sulfide solid-state electrolyte material. The invention is simple in preparation process and the prepared electrolyte is nanosized.

### TECHNICAL FIELD

The present invention belongs to the technical field of batteries and relates to a nanosized sulfide solid-state electrolyte material and a preparation method thereof.

### DESCRIPTION OF RELATED ART

Lithium-ion batteries have been widely used in many fields, including portable electronics, electric vehicles, grid storage, etc. However, for future high-mileage electric vehicles, higher energy density is required, and the energy density of commercial lithium-ion batteries has reached its limit. Additionally, leakage and thermal instability of highly flammable liquid electrolytes pose serious safety concerns for commercial lithium-ion batteries. To solve these problems, all-solid-state lithium battery technology has been widely regarded as one of the most promising candidates.

The inorganic solid-state electrolyte is non-leakage and non-volatile, and has a wide potential window and higher thermal stability, which greatly improves the safety of lithium-ion batteries. Secondly, through the successful selection of lithium anodes, the energy density of batteries can be greatly improved. In the meanwhile, inorganic solid-state electrolytes are more suitable for high-voltage cathode materials than liquid electrolytes. In inorganic solid-state electrolysis, sulfide solid-state electrolytes have high electrical conductivity and good mechanical properties.

At present, sulfide electrolyte particles have a large size (5-10 μm) and a small specific surface area. Therefore, more than 30% by mass of electrolyte powder needs to be added to the composite cathode material of all-solid-state lithium batteries to ensure that the active material in the cathode layer is in full contact with the electrolyte to achieve normal ion transmission, thus reducing the content of active material components in the cathode material.

### BRIEF SUMMARY OF THE INVENTION

In view of the deficiencies in the prior art, the present invention provides a nanosized sulfide solid-state electrolyte material and a preparation method thereof. This method achieves the purpose of refining the grain structure and reducing the particle size by adding a variety of solvents and dispersants.

One aspect of the present invention provides a nanosized sulfide solid-state electrolyte material having one or more of chemical formula I, chemical formula II, and chemical formula III:

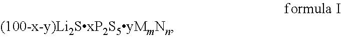

where 0≤x<100, 0≤y<100, 0≤x+y<100, 0≤m<4, 0≤n<6, M represents one or more of Li, Ge, Si, Sn, and Sb, and N represents one or more of Se, O, Cl, Br and I;

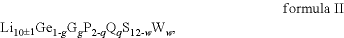

where 0≤l<1, 0≤g≤1, 0≤q≤2, 0≤w<1, G represents Si and/or Sn, Q represents Sb, and W represents one or more of O, Se, Cl, Br and I;

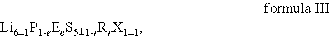

where 0≤l<1, 0≤e<1, 0≤r<1, E represents one or more of Ge, Si, Sn and Sb, R represents O and/or Se, and X represents one or more of Cl, Br and I;
the nanosized sulfide solid-state electrolyte material has a size of 10-500 nm.

The sulfide solid-state electrolyte material provided by the present invention is nanosized and has a size of 10-500 nm. As a battery electrolyte, the sulfide solid-state electrolyte material can effectively increase the contact area with an active cathode material and the ion transport capacity, thereby increasing the proportion of the active material in the composite cathode, which is conducive to the improvement of battery performance.

Preferably, the nanosized sulfide solid-state electrolyte material has a size of 10-100 nm.

Preferably, the room-temperature ionic conductivity of the nanosized sulfide solid-state electrolyte material ranges from 1×10⁻⁴ to 1×10⁻¹ S/cm. The room temperature herein refers to 15-35° C.

Preferably, the room-temperature ionic conductivity of the nanosized sulfide solid-state electrolyte material ranges from 1×10⁻³ to 5×10⁻² S/cm.

Another aspect of the present invention provides a preparation method of the nanosized sulfide solid-state electrolyte material, including the following steps:
(1) preparing a Li₂S material;
(2) mixing 10-100 parts by weight of a solvent, 0-1 parts by weight of a dispersant, and 1 part by weight of a raw material containing the Li₂S material in a closed container, and drying the mixture to obtain an electrolyte precursor powder; and
(3) heat treating, pulverizing and grinding the electrolyte precursor powder obtained in step (2) to obtain the nanosized sulfide solid-state electrolyte material.

The present invention improves the crystal nucleation rate of the electrolyte by adding a variety of solvents or adding a variety of solvents and dispersants simultaneously. On the other hand, mechanical dispersion is used to break the growing dendrites and increase the number of crystal nuclei, thereby refining the grain structure and reducing the particle size.

Preferably, a method for preparing the Li₂S material includes one or more of a ball-milling method, a carbothermic method, lithiation of a sulfur-containing chemical substance, sulfuration of metal lithium nanoparticles, and inter-reaction between lithium-containing and sulfur-containing substances.

Preferably, the solvent in step (2) is one or more of toluene, chlorobenzene, xylene, dimethyl carbonate, N-methylformamide, n-hexane, glyme, dibutyl ether, ethanol, 1,2-ethylenediamine, 1,2-ethanedithiol, acetonitrile, tetrahydrofuran, methanol, isopropyl ether, acetone, hexene, and ethyl acetate.

Preferably, the dispersant in step (2) is one or more of Triton X-100, sodium hexametaphosphate, sodium pyrophosphate, sodium tripolyphosphate, sodium lauryl sulfate, ammonium lauryl sulfate, sodium lauryl ether sulfate, polyvinylpyrrolidone, Pluronic F-127, Tween 80, and cetyltrimethylammonium bromide.

Preferably, in step (2), the part by mass of the dispersant satisfies: 0<the part by mass of the dispersant≤1. According to the present invention, a variety of solvents and dispersants are added simultaneously, which is conductive to reducing particle size.

Preferably, the operation of mixing in step (2) is implemented by way of one or more of mechanical stirring, mechanical oscillating, ultrasonic dispersion, ball milling, and roller milling.

Preferably, the mixing time is 1-48 hours.

Preferably, the operation of drying is implemented by way of one or more of vacuum filtration, vacuum drying, and blast drying.

Preferably, the operation of drying in step (2) is implemented at a temperature of 10-100° C. for 1-48 hours.

Preferably, the operation of heat treating in step (3) is implemented at a temperature of 100-600° C. for 0.5-24 hours.

Another aspect of the present invention provides an all-solid-state lithium battery, including a cathode, an anode and the nanosized sulfide solid-state electrolyte material.

Preferably, the mass percentage of the active material in the cathode ranges from 70% to 99.9%. There is no limitation on the active material and it is not limited to specific types. Any electrode active material well known to those skilled in the art could be used in the present invention.

Compared with the prior art, the present invention has the following beneficial effects.
1. The sulfide solid-state electrolyte material of the present invention is nanosized and has a size of 10-500 nm.
2. The nanosized sulfide solid-state electrolyte material of the present invention has high ionic conductivity.
3. In the preparation method of the present invention, by adding a solvent with 10 to 100 times the mass of the raw material, and in combination with mechanical dispersion, the purpose of refining the grain structure and reducing the particle size is achieved, thereby obtaining the nanosized electrolyte material.
4. In the preparation method of the present invention, solvents and dispersants are added simultaneously, and the size of the material is greatly reduced through the combined use of the solvents and the dispersants.
5. The use of the nanosized sulfide solid-state electrolyte material of the present invention as the electrolyte of an all-solid-state lithium battery can effectively increase the contact area with the active cathode material and the ion transport capacity, thereby increasing the proportion of the active material in the composite cathode to 70-99.9%, which is conducive to the improvement of battery performance.

### BRIEF DESCRIPTION OF THE SEVERAL VIEWS OF THE DRAWINGS

FIG. 1 is a SEM (Scanning Electron Microscopy) image of Li₆PS₅Cl according to Example 1.

FIG. 2 is an AC impedance spectrum of Li₆PS₅Cl according to Example 1.

FIG. 3 shows the cycling performance of a battery according to Example 1.

FIG. 4 shows charge-discharge curves of the battery according to Example 1.

FIG. 5 is a SEM image of Li_{5.4}PS_{4.4}Cl_{1.6} according to Example 2.

FIG. 6 is an AC impedance spectrum of Li_{5.4}PS_{4.4}Cl_{1.6} according to Example 2.

FIG. 7 shows the cycling performance of a battery according to Example 2.

FIG. 8 shows charge-discharge curves of the battery according to Example 2.

### DETAILED DESCRIPTION OF THE INVENTION

The technical solution of the present invention will be further described below through specific embodiments and drawings. It should be understood that the specific embodiments described here are only used to help understand the present invention and are not used to specifically limit the present invention. Unless otherwise specified, the raw materials used in the embodiments of the present invention are all commonly used raw materials in the art, and the methods used in the embodiments are all conventional methods in the art.

### Example 1

The sulfide solid-state electrolyte material having a chemical formula of Li₆PS₅Cl in this example was obtained by the following preparation method:
(1) Li₂S was prepared by the inter-reaction between lithium-containing and sulfur-containing substances. Specifically, metal lithium and elemental sulfur were dissolved in diethyl ether respectively at a molar ratio of 2.1:1, mixed and then distilled under reduced pressure; and Li₂S was obtained after reaction.
(2) In a glove box, 20 parts by weight of anhydrous acetonitrile and 1 part by weight of raw materials (the molar mass ratio of Li₂S to P₂S₅ to LiCl was 5:1:2) were mixed and stirred at 300 r/min in the container for 24 hours, and then subjected to vacuum filtration at 80° C. until there was no obvious solvent. The mixture was then transferred to a vacuum oven and dried in vacuum at 80° C. for 12 hours, and then naturally cooled to room temperature to obtain an electrolyte precursor powder.
(3) The obtained electrolyte precursor powder was heat-treated at 520° C. for 4 hours in an inert atmosphere (argon gas), and then naturally cooled to room temperature, and pulverized and ground to obtain a nanosized Li₆PS₅Cl sulfide solid-state electrolyte material.

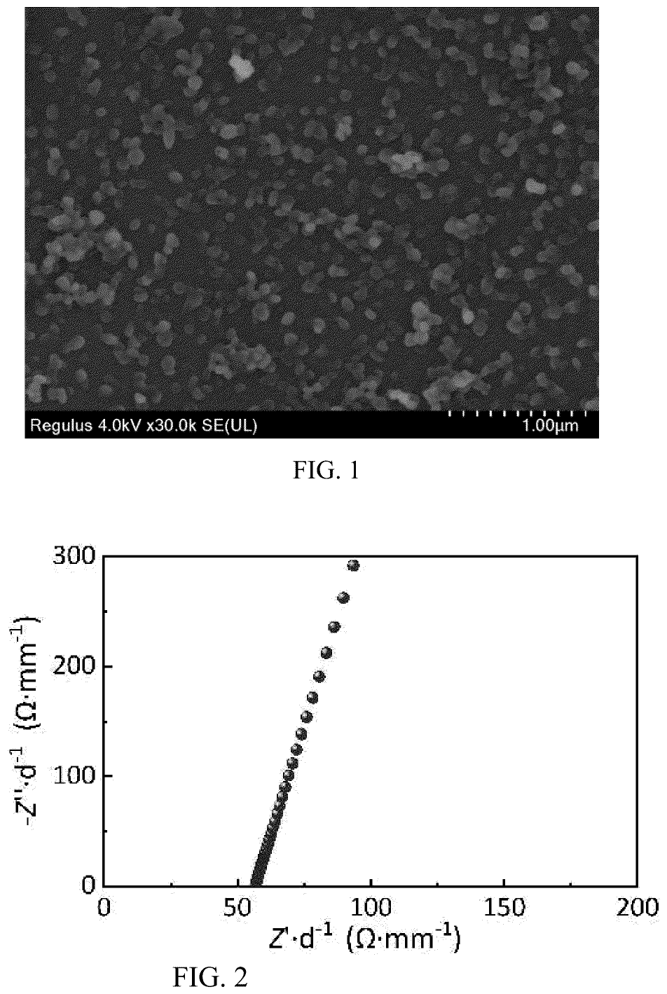

The prepared nanosized Li₆PS₅Cl sulfide solid-state electrolyte material has a particle size of 100-200 nm, and its SEM image is shown in FIG. 1. The AC impedance spectrum of the prepared nanosized Li₆PS₅Cl sulfide solid-state electrolyte material is shown in FIG. 2. The room-temperature ionic conductivity of the electrolyte is 2.3×10⁻³ S/cm.

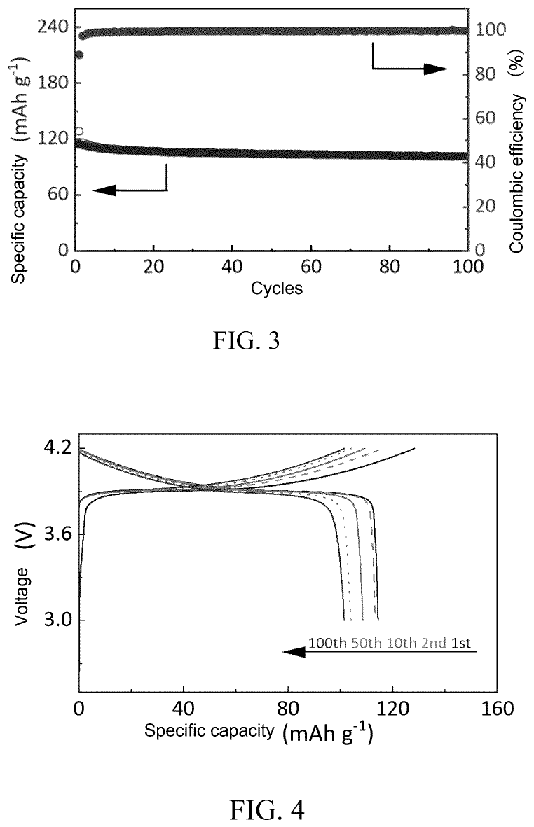

An all-solid-state battery was assembled using LiCoO₂ as an active cathode material, the above-mentioned electrolyte as an electrolyte layer and metal lithium as an anode, where LiCoO₂ accounted for 85% of the mass of the composite cathode material. The battery can be cycled stably 100 times at 1C, with a capacity retention rate of 90%. The cycling performance of the battery is shown in FIG. 3, and the charge-discharge curves of the battery are shown in FIG. 4.

### Example 2

The sulfide solid-state electrolyte material having a chemical formula of Li_{5.4}PS_{4.4}Cl_{1.6} in this example was obtained by the following preparation method:
(1) Li₂S was prepared by sulfuration of metal lithium nanoparticles. Specifically, metal lithium nanoparticles were dispersed in a tetrahydrofuran-n-hexane medium, a mixture of hydrogen sulfide gas and argon gas was introduced, and Li₂S was obtained after 24 hours of reaction.
(2) 10 parts by weight of a mixed solvent of ethanol and ethyl acetate (the volume ratio of ethanol to ethyl acetate was 4:6) and 1 part by weight of raw materials (the molar mass ratio of Li₂S to P₂S₅ to LiCl was 3.8:1:3.2) were mixed and stirred at 400 r/min in a container for 24 hours, and then subjected to vacuum filtration at 80° C. and then dried in vacuum at 80° C. for 12 hours, and naturally cooled to room temperature to obtain an electrolyte precursor powder.
(3) The obtained electrolyte precursor powder was heat-treated at 500° C. for 4 hours in an inert atmosphere (argon gas), and then naturally cooled to room temperature, and pulverized and ground to obtain a nanosized Li_{5.4}PS_{4.4}Cl_{1.6} sulfide solid-state electrolyte.

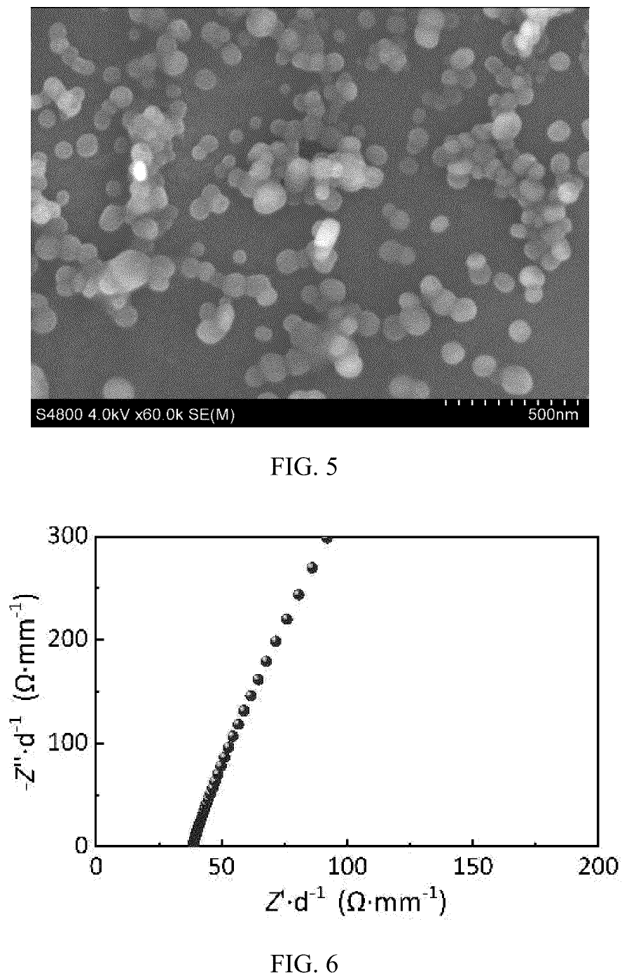

The prepared nanosized sulfide solid-state electrolyte has a particle size of 50-100 nm, and its SEM image is shown in FIG. 5. The AC impedance spectrum of the prepared nanosized sulfide solid-state electrolyte material is shown in FIG. 6. The room-temperature ionic conductivity of the electrolyte is 3.2×10⁻³ S/cm.

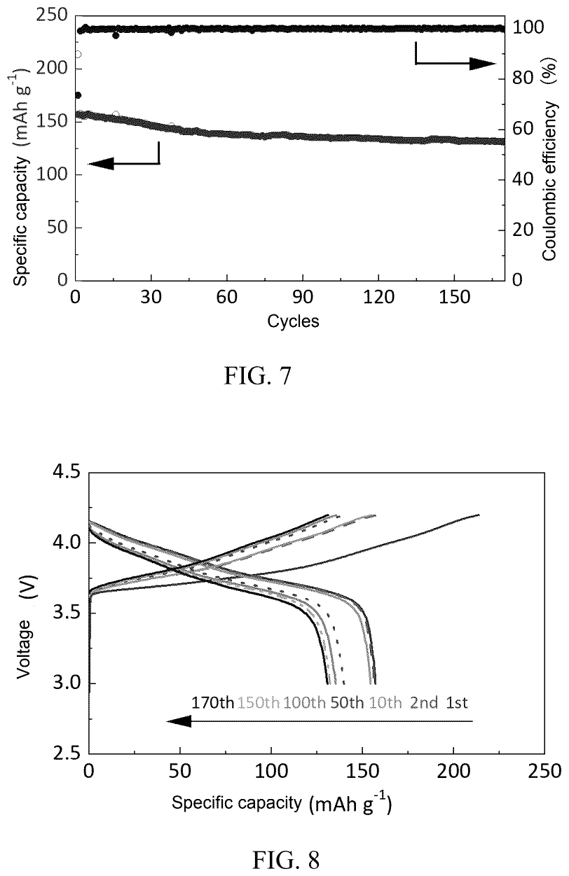

An all-solid-state battery was assembled using LiNi_{0.8}Co_{0.1}Mn_{0.1}O₂ as an active cathode material, the above-mentioned electrolyte as an electrolyte layer and metal lithium as an anode, where LiNi_{0.8}Co_{0.1}Mn_{0.1}O₂ accounted for 95% of the mass of the composite cathode material. The battery can be cycled stably 170 times at 1C, with a capacity retention rate of 83%. The cycling performance of the battery is shown in FIG. 7, and the charge-discharge curves of the battery are shown in FIG. 8.

### Example 3

The sulfide solid-state electrolyte material having a chemical formula of Li₃PS₄ in this example was obtained by the following preparation method:
(1) Li₂S was prepared by lithiation of a sulfur-containing chemical substance. Specifically, elemental sulfur powder and anhydrous lithium hydroxide were heated in a hydrogen atmosphere to obtain Li₂S.
(2) 25 parts by weight of tetrahydrofuran and 0.01 parts by weight of Triton X-100 were mixed, and 1 part by weight of raw materials (the molar mass ratio of Li₂S to P₂S₅ was 3:1) was then added. The mixture was oscillated and mixed at 300 r/min in a mixing container for 24 hours, and then subjected to vacuum filtration at 70° C. and then dried in vacuum at 70° C. for 12 hours, and naturally cooled to room temperature to obtain an electrolyte precursor powder.
(3) The obtained electrolyte precursor powder was heat-treated at 250° C. for 4 hours in an inert atmosphere (argon gas), and then naturally cooled to room temperature, and pulverized and ground to obtain a nanosized Li₃PS₄ sulfide solid-state electrolyte.

The prepared nanosized sulfide solid-state electrolyte has a particle size of about 50 nm. The room-temperature ionic conductivity of the electrolyte is 2.1×10⁻⁴ S/cm.

An all-solid-state battery was assembled using LiCoO₂ as an active cathode material, the above-mentioned electrolyte as an electrolyte layer and metal lithium as an anode, where LiCoO₂ accounted for 85% of the mass of the composite cathode material. The battery can be cycled stably 100 times at 0.1C, with a capacity retention rate of 86.1%.

### Example 4

The sulfide solid-state electrolyte material having a chemical formula of Li₇P₃S₁₁ in this example was obtained by the following preparation method:
(1) Li₂S was prepared by a carbothermic method. Specifically, anhydrous lithium sulfate, glucose and hard carbon were mixed at a mass ratio of 1:2:5, and heated to 900° C. in a hydrogen atmosphere to react to obtain Li₂S.
(2) 50 parts by weight of toluene and 0.1 parts by weight of sodium hexametaphosphate were mixed, and 1 part by weight of raw materials (the molar mass ratio of Li₂S to P₂S₅ was 7:3) was then added. The mixture was oscillated and mixed by at 500 r/min in a container for 24 hours, and then subjected to vacuum filtration at 100° C. until there was no obvious solvent. The mixture was then transferred to a vacuum oven and dried in vacuum at 100° C. for 12 hours, and then naturally cooled to room temperature to obtain an electrolyte precursor powder.
(3) The obtained electrolyte precursor powder was heat-treated at 260° C. for 4 hours in an inert atmosphere (argon gas), and then naturally cooled to room temperature, and pulverized and ground to obtain a nanosized Li₇P₃S₁₁ sulfide solid-state electrolyte.

The prepared nanosized sulfide solid-state electrolyte has a particle size of about 60 nm. The room-temperature ionic conductivity of the electrolyte is 1.2×10⁻³ S/cm.

An all-solid-state battery was assembled using LiNi_{0.6}Co_{0.2}Mn_{0.2}O₂ as an active cathode material, the above-mentioned electrolyte as an electrolyte layer and metal lithium as an anode, where LiNi_{0.6}Co_{0.2}Mn_{0.2}O₂ accounted for 88% of the mass of the composite cathode material. The battery can be cycled stably 500 times at 1C, with a capacity retention rate of 90.3%.

### Example 5

The sulfide solid-state electrolyte material having a chemical formula of Li₆PS₅Cl in this example was obtained by the following preparation method:
(1) Li₂S was prepared by ball milling. Specifically, dry sulfur powder and lithium hydride powder were mixed at a molar ratio of 1:3, and then ball-milled in a ball milling pot at room temperature at 400 r/min for 24 hours to obtain Li₂S.
(2) 30 parts by weight of a mixed solvent of tetrahydrofuran and ethanol (the volume ratio of tetrahydrofuran to ethanol was 2:1) and 0.01 parts by weight of polyvinylpyrrolidone were mixed and 1 part by weight of raw materials (the molar mass ratio of Li₂S to P₂S₅ to LiCl was 5:1:2) was then added. The mixture was ball-milled and mixed in a ball milling pot at 500 r/min for 24 hours, and then dried in vacuum at 70° C. for 24 hours, and naturally cooled to room temperature to obtain an electrolyte precursor powder.
(3) The obtained electrolyte precursor powder was heat-treated at 550° C. for 4 hours in an inert atmosphere (argon gas), and then naturally cooled to room temperature, and pulverized and ground to obtain a nanosized Li₆PS₅Cl sulfide solid-state electrolyte.

The prepared nanosized sulfide solid-state electrolyte has a particle size of about 80 nm. The room-temperature ionic conductivity of the electrolyte is 3.1×10⁻³ S/cm.

An all-solid-state battery was assembled using LiCoO₂ as an active cathode material, the above-mentioned electrolyte as an electrolyte layer and metal lithium as an anode, where LiCoO₂ accounted for 85% of the mass of the composite cathode material. The battery can be cycled stably 100 times at 2C, with a capacity retention rate of 90.1%.

### Example 6

The sulfide solid-state electrolyte material in this example was obtained by the following preparation method:
(1) Li₂S was prepared by ball milling. Specifically, dry sulfur powder and lithium hydride powder were mixed at a molar ratio of 1:2, and then ball-milled in a ball milling pot at room temperature at 500 r/min for 12 hours to obtain Li₂S.
(2) 42 parts by weight of a mixed solvent of chlorobenzene and ethyl acetate (the volume ratio of chlorobenzene to ethyl acetate was 4:6) and 0.01 parts by weight of Tween 80 were mixed and 1 part by weight of raw materials (the molar mass ratio of Li₂S to P₂S₅ to GeS₂ was 5:1:1) was then added. The mixture was ball-milled and mixed in a ball milling pot at 300 r/min for 24 hours, and then dried in vacuum at 80° C. for 24 hours, and naturally cooled to room temperature to obtain an electrolyte precursor powder.
(3) The obtained electrolyte precursor powder was heat-treated at 600° C. for 4 hours in an inert atmosphere (argon gas), and then naturally cooled to room temperature, and pulverized and ground to obtain a nanosized Li₁₀GeP₂S₁₂ and Li₃PS₄ composite sulfide solid-state electrolyte.

The prepared nanosized sulfide solid-state electrolyte has a particle size of about 20 nm. The room-temperature ionic conductivity of the electrolyte is 1.1×10⁻² S/cm.

An all-solid-state battery was assembled using LiNi_{0.8}Co_{0.15}Al_{0.05}O₂ as an active cathode material, the above-mentioned electrolyte as an electrolyte layer and metal lithium as an anode, where LiNi_{0.8}Co_{0.15}Al_{0.05}O₂ accounted for 99% of the mass of the composite cathode material. The battery can be cycled stably 500 times at 2C, with a capacity retention rate of 94.1%.

### Example 7

The sulfide solid-state electrolyte material in this example was obtained by the following preparation method:
(1) Li₂S was prepared by ball milling. Specifically, dry sulfur powder and lithium hydride powder were mixed at a molar ratio of 1:2.5, and then ball-milled in a ball milling pot at room temperature at 300 r/min for 24 hours to obtain Li₂S.
(2) 15 parts by weight of anhydrous acetonitrile and 0.01 parts by weight of Triton X-100 were mixed, and 1 part by weight of raw materials (the molar mass ratio of Li₂S to P₂S₅ to GeS₂ was 5:1:1) was then added. The mixture was stirred and mixed at 600 r/min in a container for 24 hours, and then subjected to vacuum filtration at 80° C. and then dried in vacuum at 80° C. for 12 hours, and naturally cooled to room temperature to obtain an electrolyte precursor powder.
(3) The obtained electrolyte precursor powder was heat-treated at 600° C. for 4 hours in an inert atmosphere (argon gas), and then naturally cooled to room temperature, and pulverized and ground to obtain a nanosized Li₁₀GeP₂S₁₂/Li₃PS₄ composite sulfide solid-state electrolyte.

The prepared nanosized sulfide solid-state electrolyte has a particle size of about 70 nm. The room-temperature ionic conductivity of the electrolyte is 1.2×10⁻² S/cm.

An all-solid-state battery was assembled using LiNi_{0.5}Mn_{1.5}O₄ as an active cathode material, the above-mentioned electrolyte as an electrolyte layer and metal lithium as an anode, where LiNi_{0.5}Mn_{1.5}O₄ accounted for 85% of the mass of the composite cathode material. The battery can be cycled stably 300 times at 3C, with a capacity retention rate of 91.2%.

### Example 8

The sulfide solid-state electrolyte material having a chemical formula of Li₆PS₅Br in this example was obtained by the following preparation method:
(1) Li₂S was prepared by ball milling and the inter-reaction between lithium-containing and sulfur-containing substances. Specifically, metal lithium and elemental sulfur were dissolved in tetrahydrofuran respectively at a molar ratio of 2.2:1, ball-milled and mixed at 200 r/min for 24 hours and then distilled under reduced pressure; and Li₂S was obtained after reaction.
(2) In a glove box, 25 parts by weight of dimethyl carbonate and 0.01 parts by weight of sodium tripolyphosphate were mixed, and 1 part by weight of raw materials (the molar mass ratio of Li₂S to P₂S₅ to LiBr was 5:1:2) was then added. The mixture was subjected to ultrasonic dispersion in a container for 24 hours, and then subjected to vacuum filtration at 80° C. and then dried in vacuum at 90° C. for 12 hours, and naturally cooled to room temperature to obtain an electrolyte precursor powder.
(3) The obtained electrolyte precursor powder was heat-treated at 550° C. for 4 hours in an inert atmosphere (argon gas), and then naturally cooled to room temperature, and pulverized and ground to obtain a nanosized Li₆PS₅Br sulfide solid-state electrolyte.

The prepared nanosized sulfide solid-state electrolyte has a particle size of about 40 nm. The room-temperature ionic conductivity of the electrolyte is 7.2×10⁻⁴ S/cm.

An all-solid-state battery was assembled using LiCoO₂ as an active cathode material, the above-mentioned electrolyte as an electrolyte layer and metal lithium as an anode, where LiCoO₂ accounted for 83% of the mass of the composite cathode material. The battery can be cycled stably 100 times at 0.1C, with a capacity retention rate of 92.6%.

### Example 9

The sulfide solid-state electrolyte material having a chemical formula of Li_{5.4}PS_{4.4}Cl_{1.2}Br_{0.4} in this example was obtained by the following preparation method:
(1) Li₂S was prepared by ball milling. Specifically, dry sulfur powder and lithium hydride powder were mixed at a molar ratio of 1:1, and then ball-milled in a ball milling pot at room temperature at 100 r/min for 24 hours to obtain Li₂S.
(2) 64 parts by weight of a mixed solvent of tetrahydrofuran and ethanol (the volume ratio of tetrahydrofuran to ethanol was 2:1) and 0.01 parts by weight of sodium lauryl ether sulfate were mixed and 1 part by weight of raw materials (the molar mass ratio of Li₂S to P₂S₅ to LiCl to LiBr was 3.8:1:2.4:0.8) was then added. The mixture was roller-milled and mixed in a container at 300 r/min for 24 hours, and then subjected to vacuum filtration at 120° C. and then dried in vacuum at 120° C. for 12 hours, and naturally cooled to room temperature to obtain an electrolyte precursor powder.
(3) The obtained electrolyte precursor powder was heat-treated at 550° C. for 4 hours in an inert atmosphere (argon gas), and then naturally cooled to room temperature, and pulverized and ground to obtain a nanosized Li_{5.4}PS_{4.4}Cl_{1.2}Br_{0.4} sulfide solid-state electrolyte.

The prepared nanosized sulfide solid-state electrolyte has a particle size of about 30 nm. The room-temperature ionic conductivity of the electrolyte is 6.8×10⁻³ S/cm.

An all-solid-state battery was assembled using Co₉S₈ as an active cathode material, the above-mentioned electrolyte as an electrolyte layer and metal lithium as an anode, where Co₉S₈ accounted for 90% of the mass of the composite cathode material. The battery can be cycled stably 100 times at 1C, with a capacity retention rate of 90.4%.

### Example 10

The sulfide solid-state electrolyte material having a chemical formula of Li_{5.4}PS_{4.4}Cl_{1.6} in this example was obtained by the following preparation method:
(1) Li₂S was prepared by sulfuration of metal lithium nanoparticles. Specifically, metal lithium nanoparticles were dispersed in a tetrahydrofuran-n-hexane medium, a mixture of hydrogen sulfide gas and argon gas was introduced, and Li₂S was obtained after 24 hours of reaction.
(2) 1 part by weight of raw materials (the molar mass ratio of Li₂S to P₂S₅ to LiCl was 3.8:1:3.2) was added to 75 parts by weight of acetonitrile. The mixture was roller-milled and mixed at 400 r/min in a container for 24 hours, and then subjected to vacuum filtration at 70° C. and then dried in vacuum at 70° C. for 12 hours, and naturally cooled to room temperature to obtain an electrolyte precursor powder.
(3) The obtained electrolyte precursor powder was heat-treated at 500° C. for 4 hours in an inert atmosphere (argon gas), and then naturally cooled to room temperature, and pulverized and ground to obtain a nanosized Li_{5.4}PS_{4.4}Cl_{1.6} sulfide solid-state electrolyte.

The prepared nanosized sulfide solid-state electrolyte has a particle size of about 150 nm. The room-temperature ionic conductivity of the electrolyte is 6.2×10⁻³ S/cm.

An all-solid-state battery was assembled using LiCoO₂ as an active cathode material, the above-mentioned electrolyte as an electrolyte layer and metal lithium as an anode, where LiCoO₂ accounted for 80% of the mass of the composite cathode material. The battery can be cycled stably 500 times at 0.5C, with a capacity retention rate of 90.3%.

### Example 11

The sulfide solid-state electrolyte material having a chemical formula of Li₇P₂S₈I in this example was obtained by the following preparation method:
(1) Li₂S was prepared by the inter-reaction between lithium-containing and sulfur-containing substances. Specifically, metal lithium and elemental sulfur were dissolved in toluene respectively at a molar ratio of 2.1:1, mixed and then distilled under reduced pressure; and Li₂S was obtained after reaction.
(2) In a glove box, 90 parts by weight of acetone and 0.01 parts by weight of Triton X-100 were mixed, and 1 part by weight of raw materials (the molar mass ratio of Li₂S to P₂S₅ to Lil was 3:1:1) was then added. The mixture was stirred and mixed in a container for 24 hours, and then subjected to vacuum filtration at 60° C. and then dried in vacuum at 60° C. for 12 hours, and naturally cooled to room temperature to obtain an electrolyte precursor powder.
(3) The obtained electrolyte precursor powder was heat-treated at 200° C. for 4 hours in an inert atmosphere (argon gas), and then naturally cooled to room temperature, and pulverized and ground to obtain a nanosized Li₇P₂S₈I sulfide solid-state electrolyte.

The prepared nanosized sulfide solid-state electrolyte has a particle size of about 100 nm. The room-temperature ionic conductivity of the electrolyte is 1.4×10⁻⁴ S/cm.

An all-solid-state battery was assembled using LiNi_{0.6}Co_{0.2}Mn_{0.2}O₂ as an active cathode material, the above-mentioned electrolyte as an electrolyte layer and metal lithium as an anode, where LiNi_{0.6}Co_{0.2}Mn_{0.2}O₂ accounted for 75% of the mass of the composite cathode material. The battery can be cycled stably 500 times at 0.1C, with a capacity retention rate of 90.3%.

### Example 12

The sulfide solid-state electrolyte material in this example was obtained by the following preparation method:
(1) Li₂S was prepared by ball milling. Specifically, dry sulfur powder and lithium hydride powder were mixed at a molar ratio of 1:2, and then ball-milled in a ball milling pot at room temperature at 500 r/min for 12 hours to obtain Li₂S.
(2) 55 parts by weight of hexene and 0.01 parts by weight of hexadecyltrimethylammonium bromide were mixed, and 1 part by weight of raw materials (the molar mass ratio of Li₂S to P₂S₅ to GeS₂ was 5:1:1) was then added. The mixture was oscillated and mixed at 500 r/min in a container for 24 hours, and then subjected to vacuum filtration at 70° C. and then dried in vacuum at 70° C. for 12 hours, and naturally cooled to room temperature to obtain an electrolyte precursor powder.
(3) The obtained electrolyte precursor powder was heat-treated at 600° C. for 4 hours in an inert atmosphere (argon gas), and then naturally cooled to room temperature, and pulverized and ground to obtain a nanosized Li₁₀GeP₂S₁₂/Li7P₂S₈I composite sulfide solid-state electrolyte.

The prepared nanosized sulfide solid-state electrolyte has a particle size of about 90 nm. The room-temperature ionic conductivity of the electrolyte is 9.38×10⁻³ S/cm.

An all-solid-state battery was assembled using LiCoO₂ as an active cathode material, the above-mentioned electrolyte as an electrolyte layer and metal lithium as an anode, where LiCoO₂ accounted for 83% of the mass of the composite cathode material. The battery can be cycled stably 500 times at 1C, with a capacity retention rate of 91.5%.

### Example 13

The sulfide solid-state electrolyte material in this example was obtained by the following preparation method:
(1) Li₂S was prepared by ball milling. Specifically, dry sulfur powder and lithium hydride powder were mixed at a molar ratio of 1:2, and then ball-milled in a ball milling pot at room temperature at 500 r/min for 12 hours to obtain Li₂S.
(2) 55 parts by weight of a mixed solution of hexene and ethanol (the volume ratio of hexene to ethanol was 3:2) and 0.01 parts by weight of Triton were mixed, and 1 part by weight of raw materials (the molar mass ratio of Li₂S to P₂S₅ to GeS₂ was 5:1:1) was then added. The mixture was oscillated and mixed at 500 r/min in a container for 24 hours, and then subjected to vacuum filtration at 70° C. and then dried in vacuum at 70° C. for 12 hours, and naturally cooled to room temperature to obtain an electrolyte precursor powder.
(3) The obtained electrolyte precursor powder was heat-treated at 600° C. for 4 hours in an inert atmosphere (argon gas), and then naturally cooled to room temperature, and pulverized and ground to obtain a nanosized Li₁₀GeP₂S₁₂ and Li₇P₂S₈I composite sulfide solid-state electrolyte.

The prepared nanosized sulfide solid-state electrolyte has a particle size of about 60 nm. The room-temperature ionic conductivity of the electrolyte is 9.62×10⁻³ S/cm.

An all-solid-state battery was assembled using LiCoO₂ as an active cathode material, the above-mentioned electrolyte as an electrolyte layer and metal lithium as an anode, where LiCoO₂ accounted for 90% of the mass of the composite cathode material. The battery can be cycled stably 1500 times at 1C, with a capacity retention rate of 90.5%.

### Comparative Example 1

A sulfide solid-state electrolyte material having a chemical formula of Li₆PS₅Cl was prepared in this comparative example and its preparation method is the same as the preparation method of Example 1 except that 2 parts by weight of absolute ethanol and 1 part by weight of raw materials (the molar mass ratio of Li₂S to P₂S₅ to LiCl was 5:1:2) were mixed in Comparative Example 1.

The prepared sulfide solid-state electrolyte has a particle size of 5 μm. The room-temperature ionic conductivity of the electrolyte is 2×10⁻³ S/cm.

An all-solid-state battery was assembled using LiCoO₂ as an active cathode material, the above-mentioned electrolyte as an electrolyte layer and metal lithium as an anode, where LiCoO₂ accounted for 70% of the mass of the composite cathode material. The battery can be cycled stably 100 times at 0.1C, with a capacity retention rate of 82%.

### Comparative Example 2

A sulfide solid-state electrolyte material having a chemical formula of Li₆PS₅Cl was prepared in this comparative example and its preparation method is the same as the preparation method of Example 1 except that no solvent was mixed with the raw materials in Comparative Example 2.

The prepared sulfide solid-state electrolyte has a particle size of about 10-50 μm. The room-temperature ionic conductivity of the electrolyte is 2.2×10⁻³ S/cm.

An all-solid-state battery was assembled using LiCoO₂ as an active cathode material, the above-mentioned electrolyte as an electrolyte layer and metal lithium as an anode, where LiCoO₂ accounted for 70% of the mass of the composite cathode material. The battery can be cycled stably 100 times at 0.1C, with a capacity retention rate of 80%.

### Comparative Example 3

A sulfide solid-state electrolyte material prepared in this comparative example was Li₁₀GeP₂S₁₂ and Li₇P₂S₈I composite sulfide solid-state electrolyte and its preparation method is the same as the preparation method of Example 13 except that no dispersant (Triton) was added in Comparative Example 3.

The prepared sulfide solid-state electrolyte has a particle size of about 10 μm. The room-temperature ionic conductivity of the electrolyte is 7×10-3 S/cm.

An all-solid-state battery was assembled using LiCoO₂ as an active cathode material, the above-mentioned electrolyte as an electrolyte layer and metal lithium as an anode, where LiCoO₂ accounted for 70% of the mass of the composite cathode material. The battery can be cycled for 100 times at 0.1C, with a capacity retention rate of 83%.

Finally, it should be noted that the specific embodiments described herein are merely used to describing the spirit of the invention by way of examples, and are not intended to limit the embodiments of the invention. Those skilled in the technical field to which the invention belongs can make various modifications, supplements or similar substitutions to the specific embodiments described here, and it is unnecessary and impossible to exhaust all possible embodiments of the invention. All obvious changes or transformations derived based on the essential spirit of the invention should fall within the protection scope of the invention, and it is against the spirit of the invention to interpret these changes or transformations as any additional limitations.

What is claimed is:

1. A nanosized sulfide solid-state electrolyte material having one or more chemical formulas of formula I, formula II, and formula III: 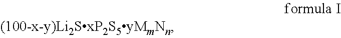
wherein 0≤x<100, 0≤y<100, 0≤x+y<100, 0≤m<4, 0≤n<6, M represents one or more of Li, Ge, Si, Sn, and Sb, and N represents one or more of Se, O, Cl, Br and I; 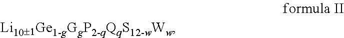
wherein 0≤l<1, 0g≤1, 0≤q≤2, 0≤w<1, G represents Si and/or Sn, Q represents Sb, and W represents one or more of O, Se, Cl, Br and I; 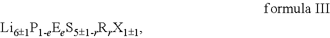
wherein 0≤l<1, 0≤e<1, 0≤r<1, E represents one or more of Ge, Si, Sn and Sb, R represents O and/or Se, and X represents one or more of Cl, Br and I;
the nanosized sulfide solid-state electrolyte material has a size of 10-500 nm.

2. The nanosized sulfide solid-state electrolyte material according to claim 1, wherein the nanosized sulfide solid-state electrolyte material has a size of 10-100 nm.

3. The nanosized sulfide solid-state electrolyte material according to claim 1, wherein the room-temperature ionic conductivity of the nanosized sulfide solid-state electrolyte material ranges from 1×10⁻⁴ to 1×10⁻¹ S/cm.

4. A preparation method of the nanosized sulfide solid-state electrolyte material according to claim 1, comprising the following steps:
(1) preparing a Li₂S material;
(2) mixing 10-100 parts by weight of a solvent, 0-1 parts by weight of a dispersant, and 1 part by weight of a raw material containing the Li₂S material in a closed container, and drying the mixture to obtain an electrolyte precursor powder; and
(3) heat treating, pulverizing and grinding the electrolyte precursor powder obtained in step (2) to obtain the nanosized sulfide solid-state electrolyte material.

5. The preparation method according to claim 4, wherein a method for preparing the Li₂S material comprises one or more of a ball-milling method, a carbothermic method, lithiation of a sulfur-containing chemical substance, sulfuration of metal lithium nanoparticles, and inter-reaction between lithium-containing and sulfur-containing substances.

6. The preparation method according to claim 4, wherein the solvent in step (2) is one or more of toluene, chlorobenzene, xylene, dimethyl carbonate, N-methylformamide, n-hexane, glyme, dibutyl ether, ethanol, 1,2-ethylenediamine, 1,2-ethanedithiol, acetonitrile, tetrahydrofuran, methanol, isopropyl ether, acetone, hexene, and ethyl acetate.

7. The preparation method according to claim 4, wherein the dispersant in step (2) is one or more of Triton X-100, sodium hexametaphosphate, sodium pyrophosphate, sodium tripolyphosphate, sodium lauryl sulfate, ammonium lauryl sulfate, sodium lauryl ether sulfate, polyvinylpyrrolidone, Pluronic F-127, Tween 80, and cetyltrimethylammonium bromide.

8. The preparation method according to claim 4, wherein in step 2), the part by mass of the dispersant satisfies: 0<the part by mass of the dispersant≤1.

9. The preparation method according to claim 4, wherein the operation of mixing in step (2) is implemented by way of one or more of mechanical stirring, mechanical oscillating, ultrasonic dispersion, ball milling, and roller milling.

10. The preparation method according to claim 4, wherein the mixing time in step (2) is 1-48 hours.

11. The preparation method according to claim 4, wherein the operation of drying in step (2) is implemented at a temperature of 10-100° C. for 1-48 hours.

12. The preparation method according to claim 4, wherein the operation of heat treating in step (3) is implemented at a temperature of 100-600° C. for 0.5-24 hours.

13. An all-solid-state lithium battery, comprising a cathode, an anode and the nanosized sulfide solid-state electrolyte material according to claim 1.

14. The all-solid-state lithium battery according to claim 13, wherein the mass percentage of the active material in the cathode ranges from 70% to 99.9%.
